(19) United States
(12) Patent Application Publication
(10) Pub. No.: US 2014/0253535 A1
(43) Pub. Date: Sep. 11, 2014

(54) DISPLAY INTERFACE THAT COMPRESSES/DECOMPRESSES IMAGE DATA, METHOD OF OPERATING SAME, AND DEVICE INCLUDING SAME

(71) Applicants: Jung Pil LIM, Hwaseong-si (KR); Dong Myung LEE, Yongin-si (KR); Han Si PAE, Seongnam-si (KR); Kil Hoon LEE, Seoul (KR); Jae Youl LEE, Hwaseong-si (KR)

(72) Inventors: Jung Pil LIM, Hwaseong-si (KR); Dong Myung LEE, Yongin-si (KR); Han Si PAE, Seongnam-si (KR); Kil Hoon LEE, Seoul (KR); Jae Youl LEE, Hwaseong-si (KR)

(21) Appl. No.: 14/191,828

(22) Filed: Feb. 27, 2014

(30) Foreign Application Priority Data
Mar. 5, 2013 (KR) 10-2013-0023453

(51) Int. Cl. G09G 5/00

(52) U.S. Cl. CPC G09G 5/008
USPC 345/213

(57) ABSTRACT

A source driver integrated circuit (IC) includes a logic circuit configured to receive a transmission data packet including data, a compression code indicating compression or non-compression of the data, and a clock signal, to interpret the compression code, and to generate a sleep mode enable signal based on an interpretation result, and a clock signal recovery circuit configured to enable one of a voltage-controlled delay line and a voltage-controller oscillator in response to the sleep mode enable signal.

### CROSS-REFERENCE TO RELATED APPLICATIONS

This application claims the benefit of priority under 35 U.S.C. §119(a) to Korean Patent Application No. 10-2013-0023453, filed on Mar. 5, 2013, the content of which is incorporated herein in its entirety by reference.

### BACKGROUND

Embodiments of the inventive concept relate to a display interface, and more particularly, to a display interface that compares line data between two adjacent lines and that compresses data to be transmitted or that decompresses compressed data according to the comparison result and a display device including the same.

With the increase in the size of a display in mobile devices, such as notebook computers and tablet personal computers (PCs), and the increase in the resolution of the display, the operation speed of a display interface should be similarly increased and the power consumption thereof should be decreased. When the amount of display data transmitted through the display interface increases, the power consumption of the display interface also increases.

### SUMMARY

Additional features and utilities of the present general inventive concept will be set forth in part in the description which follows and, in part, will be obvious from the description, or may be learned by practice of the general inventive concept.

The foregoing and/or other features and utilities of the present inventive concept may be achieved by providing a timing controller including a logic circuit configured to compare previous line data with current line data, to compress the current line data based on a comparison result, and to generate a transmission data packet including a compression code indicating compression or non-compression of the current line data, compressed data, and sleep data, and a transmitter configured to transmit the transmission data packet.

The logic circuit may include a line data comparator configured to compare the previous line data with the current line data and to generate the compression code based on the comparison result, and a data generation circuit configured to compress the current line data based on the compression code and to generate the transmission data packet.

The logic circuit may be configured to generate the compressed data including a number of a changed pixel detected based on the comparison result and pixel data of a pixel.

The logic circuit may be configured to generate a transmitter sleep mode enable signal when the sleep data is transmitted and the transmitter is disabled in response to the transmitter sleep mode enable signal.

The foregoing and/or other features and utilities of the present inventive concept also provide a source driver integrated circuit (IC) including a logic circuit configured to receive a transmission data packet including data, a compression code indicating compression or non-compression of the data, and a clock signal, to interpret the compression code, and to generate a sleep mode enable signal based on an interpretation result, and a clock signal recovery circuit configured to enable a voltage-controlled delay line or a voltage-controller oscillator in response to the sleep mode enable signal.

The voltage-controlled delay line may be configured to generate a plurality of first recovery clock signals in response to the sleep mode enable signal indicating non-compression of the data and the voltage-controller oscillator may be configured to generate a plurality of second recovery clock signals in response to the sleep mode enable signal indicating compression of the data.

The source driver IC may further include a control voltage maintaining circuit configured to supply a constant control voltage to the voltage-controller oscillator when the voltage-controller oscillator is enabled.

The voltage-controller oscillator may be configured to share a part of the voltage-controlled delay line.

The source driver IC may further include a reference clock generation circuit configured to generate a reference clock signal based on the clock signal, a phase-frequency detector configured to receive the reference clock signal and an output clock signal of the voltage-controlled delay line, a control voltage generation circuit configured to generate a control voltage in response to at least one control signal output from the phase-frequency detector, the control voltage supplied to the voltage-controlled delay line, and a control voltage maintaining circuit configured to maintain the control voltage constant in response to the sleep mode enable signal.

Alternatively, the source driver IC may further include a reference clock generation circuit configured to generate a reference clock signal based on the clock signal, a bang-bang phase detector configured to receive the reference clock signal and an output clock signal of the voltage-controlled delay line, and a control voltage supply circuit configured to generate a count value in response to at least one control signal output from the bang-bang phase detector, to generate a control voltage based on the count value, and to supply the control voltage to the voltage-controlled delay line.

As another alternative, the source driver IC may further include a reference clock generation circuit configured to generate a reference clock signal based on the clock signal, a time-to-digital converter configured to receive the reference clock signal and an output clock signal of the voltage-controlled delay line, a digital loop filter connected to the time-to-digital converter, and a control voltage supply circuit configured to generate a control voltage based on a control code output from the digital loop filter and to supply the control voltage to the voltage-controlled delay line.

The clock signal recovery circuit may include a selection circuit configured to output recovery clock signals of the voltage-controlled delay line or recovery clock signals of the voltage-controller oscillator in response to the sleep mode enable signal.

The logic circuit may be configured to recover display data from the data based on recovery clock signals output from one of the voltage-controlled delay line and the voltage-controller oscillator.

The voltage-controlled delay line may include a plurality of voltage-controlled delay line cells connected in series. The clock signal recovery circuit may include an inverter configured to receive an output signal of one of the voltage-controlled delay line cells, and a selection circuit configured to apply one of a reference clock signal generated based on the clock signal and an output signal of the inverter to a first voltage-controlled delay line cell in response to the sleep mode enable signal. The voltage-controller oscillator may include some of the voltage-controlled delay line cells and the inverter.

The foregoing and/or other features and utilities of the present inventive concept also provide a display device including a display panel and a source driver IC configured to drive the display panel based on display data. The source driver IC may include a logic circuit configured to receive a transmission data packet having data, a compression code indicating compression or non-compression of the data, and a clock signal, to interpret the compression code, and to generate a sleep mode enable signal based on an interpretation result, and a clock signal recovery circuit configured to enable a voltage-controlled delay line or a voltage-controller oscillator in response to the sleep mode enable signal. The logic circuit may be configured to recover the display data from the data based on recovery clock signals output from the voltage-controlled delay line or the voltage-controller oscillator.

The voltage-controlled delay line may include a plurality of voltage-controlled delay line cells connected in series. The clock signal recovery circuit may include an inverter configured to receive an output signal of one of the voltage-controlled delay line cells, and a selection circuit configured to apply a reference clock signal generated based on the clock signal or an output signal of the inverter to a first voltage-controlled delay line cell in response to the sleep mode enable signal. The voltage-controller oscillator may include some of the voltage-controlled delay line cells and the inverter.

The voltage-controlled delay line may be configured to generate the recovery clock signals in response to the sleep mode enable signal indicating non-compression of the data and the voltage-controller oscillator is configured to generate the recovery clock signals in response to the sleep mode enable signal indicating compression of the data.

The display device may further include a control voltage maintaining circuit configured to supply a constant control voltage to the voltage-controller oscillator in response to the sleep mode enable signal.

The voltage-controller oscillator may be configured to share a part of the voltage-controlled delay line.

The display device may further include a reference clock generation circuit configured to generate a reference clock signal based on the clock signal, a phase-frequency detector configured to receive the reference clock signal and an output clock signal of the voltage-controlled delay line, a control voltage generation circuit configured to generate a control voltage in response to at least one control signal output from the phase-frequency detector, the control voltage supplied to the voltage-controlled delay line, and a control voltage maintaining circuit configured to maintain the control voltage constant in response to the sleep mode enable signal.

Alternatively, the display device may further include a reference clock generation circuit configured to generate a reference clock signal based on the clock signal, a bang-bang phase detector configured to receive the reference clock signal and an output clock signal of the voltage-controlled delay line, and a control voltage supply circuit configured to generate a count value in response to at least one control signal output from the bang-bang phase detector, to generate a control voltage based on the count value, and to supply the control voltage to the voltage-controlled delay line.

As another alternative, the display device may further include a reference clock generation circuit configured to generate a reference clock signal based on the clock signal, a time-to-digital converter configured to receive the reference clock signal and an output clock signal of the voltage-controlled delay line, a digital loop filter connected to the time-to-digital converter, and a control voltage supply circuit configured to generate a control voltage based on a control code output from the digital loop filter and to supply the control voltage to the voltage-controlled delay line.

The display device may be a mobile equipment.

The foregoing and/or other features and utilities of the present inventive concept also provide a method of operating a display interface, the method including comparing previous line data with current line data, generating a compression code indicating compression or non-compression of the current line data based on a comparison result, compressing the current line data based on the compression code, generating a transmission data packet including the compression code, compressed data, and sleep data, and transmitting the transmission data packet through a channel.

The method may further include receiving the transmission data packet through the channel, interpreting the compression code included in the transmission data packet, generating a sleep mode enable signal based on an interpretation result, and enabling a voltage-controlled delay line or a voltage-controller oscillator in response to the sleep mode enable signal.

The foregoing and/or other features and utilities of the present inventive concept also provide an integrated circuit including a circuit configured to compress line data for a display device and to generate a data packet that includes a code that has an indication of a state of compression and information related to a sleep mode, and a transmitter configured to transmit the data packet.

The state of compression may be a state of being uncompressed.

The state of compression may be a state of being compressed by at least one of a changed pixel information encoding (CPIE) method and a run length encoding (RLE) method.

The foregoing and/or other features and utilities of the present inventive concept also provide a method of operating a display interface including compressing current line data for a display, and generating a data packet that includes the current line data and a code that has an indication of a state of compression and information related to a sleep mode.

The method may further include transmitting the data packet.

The compressing may include comparing the current line data with previous line data.

The data packet may further include data configured to be transmitted during the sleep mode.

The foregoing and/or other features and utilities of the present inventive concept also provide an integrated circuit including a first circuit configured to receive a data packet that includes information related to a sleep mode and to generate a signal in response to the information, and a second circuit configured to enable one of a voltage-controlled delay line and a voltage-controller oscillator in response to the signal.

The voltage-controlled delay line may include a first voltage-controlled delay line and a second voltage-controlled delay line, and the voltage-controller oscillator may include the first voltage-controlled delay line and an inverter.

The foregoing and/or other features and utilities of the present inventive concept also provide a method of operating a timing controller including receiving a data packet that includes information related to a sleep mode, generating a signal in response to the information, and enabling one of a voltage-controlled delay line and a voltage-controller oscillator in response to the signal.

The method may further include using the one of the voltage-controlled delay line and the voltage-controller oscillator to generate clock signals, and using the clock signals to recover data from the data packet.

The information related to the sleep mode may be included in a code, and the code may further include an indication of a status of compression of data in the data packet.

The data packet may further include data configured to be transmitted during the sleep mode.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating a display module according to an embodiment of the present inventive concept;

FIG. 2 is a schematic block diagram illustrating an example of a timing controller and a source driver integrated circuit (IC) illustrated in FIG. 1;

FIG. 3 is a schematic block diagram illustrating a timing controller according to an embodiment of the present inventive concept;

FIGS. 4A through 4C are diagrams illustrating data packets according to an embodiment of the present inventive concept;

FIGS. 5A and 5B are diagrams illustrating data packets that includes a compression code according to an embodiment of the present inventive concept;

FIG. 6 is a diagram illustrating compression algorithms according to an embodiment of the present inventive concept;

FIGS. 7A through 7C are diagrams illustrating data packets according to various embodiments of the present inventive concept;

FIGS. 8A through 8C are diagrams illustrating transmission data packets according to various embodiments of the present inventive concept;

FIG. 9 is a schematic block diagram illustrating a clock signal-data recovery (CDR) circuit according to an embodiment of the present inventive concept;

FIG. 10 is a timing chart illustrating an example of an operation of the CDR circuit illustrated in FIG. 9;

FIG. 11 is a timing chart illustrating an example of an operation signals of a reference clock generation circuit illustrated in FIG. 9;

FIG. 12 is a schematic block diagram illustrating an example of a reference clock generation circuit illustrated in FIG. 9;

FIG. 13 is a circuit diagram illustrating an example of a clock signal recovery circuit illustrated in FIG. 9;

FIG. 14 is a timing chart illustrating an example of an operation of the clock signal recovery circuit illustrated in FIG. 13;

FIGS. 15 through 17 are schematic block diagrams illustrating CDR circuits according to various embodiments of the present inventive concept;

FIG. 18 is a circuit diagram illustrating an example of a digital-to-analog converter (DAC) illustrated in FIG. 17;

FIGS. 19 and 20 are schematic block diagrams illustrating CDR circuits according to various embodiments of the present inventive concept;

FIG. 21 is a flowchart illustrating an operation of a timing controller according to an embodiment of the present inventive concept;

FIG. 22 is a flowchart illustrating an operation of a CDR circuit and a logic circuit and a driving block according to an embodiment of the present inventive concept;

FIG. 23 is a schematic block diagram illustrating a timing controller according to an embodiment of the present inventive concept;

FIGS. 24A and 24B are diagrams illustrating examples of pixel structures of a display panel illustrated in FIG. 1;

FIG. 25 is a schematic diagram illustrating an example of a driver cell array of the source driver IC illustrated in FIG. 1; and

FIG. 26 is a block diagram illustrating a display device that includes a display module according to an embodiment of the present inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

The present general inventive concept may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the present general inventive concept. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

In the embodiments described below, a display interface includes a timing controller and/or a source driver integrated circuit (IC). The timing controller may compress image data and may generate a transmission data packet including a compression code indicating the compression or non-compression of the image data. The source driver IC may interpret the compression code included in the transmission data packet, may generate a recovery clock signal using a voltage-controlled delay line or a voltage-controlled oscillator according an interpretation result, and may decompress the compressed data using the recovery clock signal.

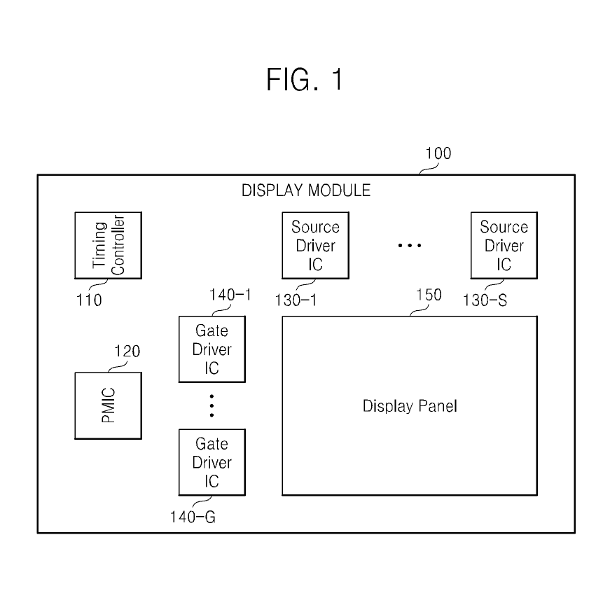

FIG. 1 is a block diagram that illustrates a display module 100 according to an embodiment of the present inventive concept.

The display module 100 may include a timing controller 110, a power management integrated circuit (PMIC) 120, a plurality of source driver integrated circuits (ICs) 130-1 through 130-S (where S is a natural number), a plurality of gate driver integrated circuits (ICs) 140-1 through 140-G (where G is a natural number), and a display panel 150.

The timing controller 110 may control the operations of the source driver ICs 130-1 through 130-S and the gate driver ICs 140-1 through 140-G. The timing controller 110 may compare previous line data with current line data, may compress the current line data based on a comparison result, and may transmit a transmission data packet, which may include a compression code that indicates the compression or non-compression of the current line data, compressed data, and sleep data, to the source driver ICs 130-1 through 130-S through channels.

The sleep data may be a set of data at a direct current (DC) level, e.g., a low level or a signal that does not toggle. Accordingly, the sleep data may be transmitted in a sleep mode or during a sleep period, and therefore, the power consumption of the timing controller 110 may be reduced.

The PMIC 120 may supply a necessary operating voltage to the timing controller 110, the source driver ICs 130-1 through 130-S, and the gate driver ICs 140-1 through 140-G. The source driver ICs 130-1 through 130-S and the gate driver ICs 140-1 through 140-G may drive a plurality of pixels included in the display panel 150.

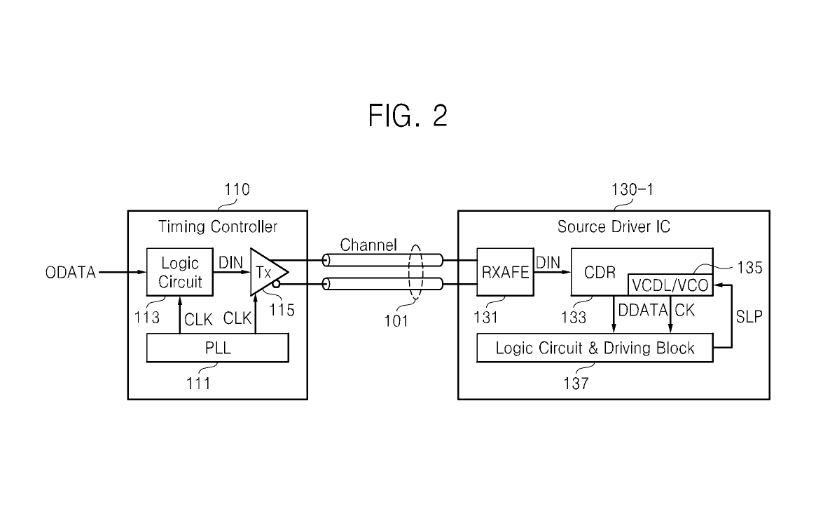

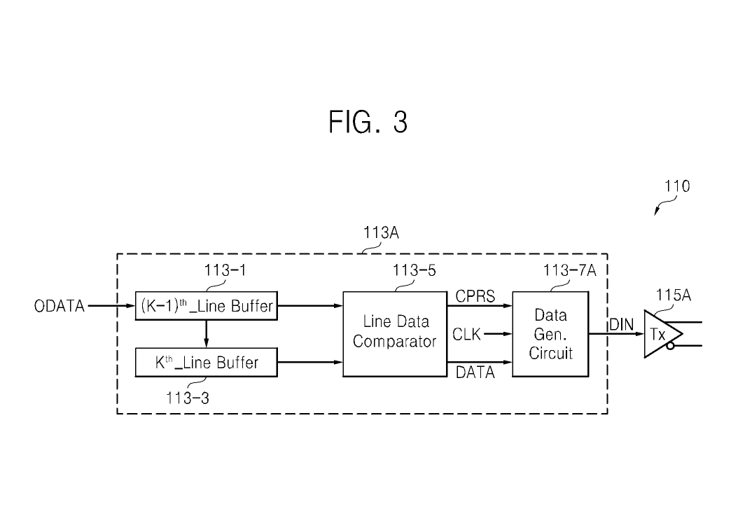

FIG. 2 is a schematic block diagram that illustrates an example of the timing controller 110 and the source driver IC 130-1 illustrated in FIG. 1. FIG. 3 is a schematic block diagram that illustrates the timing controller 110 according to some an embodiment of the present inventive concept. Referring to FIGS. 2 and 3, the timing controller 110 may include a phase-locked loop (PLL) 111, a logic circuit 113, and a transmitter 115.

The PLL 111 may apply a clock signal CLK to the logic circuit 113 and the transmitter 115.

The logic circuit 113 may compare previous line data in original display data ODATA with current line data in the original display data ODATA pixel by pixel, may compress the current line data base on a comparison result, and may transmit a transmission data packet DIN, which may include a compression code CPRS that indicates the compression or non-compression of the current line data, compressed data, and sleep data, to the transmitter 115. A logic circuit 113A, an example of the logic circuit 113, may include a first line buffer 113-1, a second line buffer 113-3, a line data comparator 113-5, and a data generation circuit 113-7A.

The first line buffer 113-1 may store (K−1)-th line data, i.e., the previous line data in the original display data ODATA. The second line buffer 113-3 may store K-th line data, i.e., the current line data in the original display data ODATA.

The line data comparator 113-5 may compare the previous line data with the current line data pixel by pixel and may generate the compression code CPRS that indicates the compression or non-compression of the current line data and may generate data (hereinafter, referred to as “related data”) DATA related to the current line data.

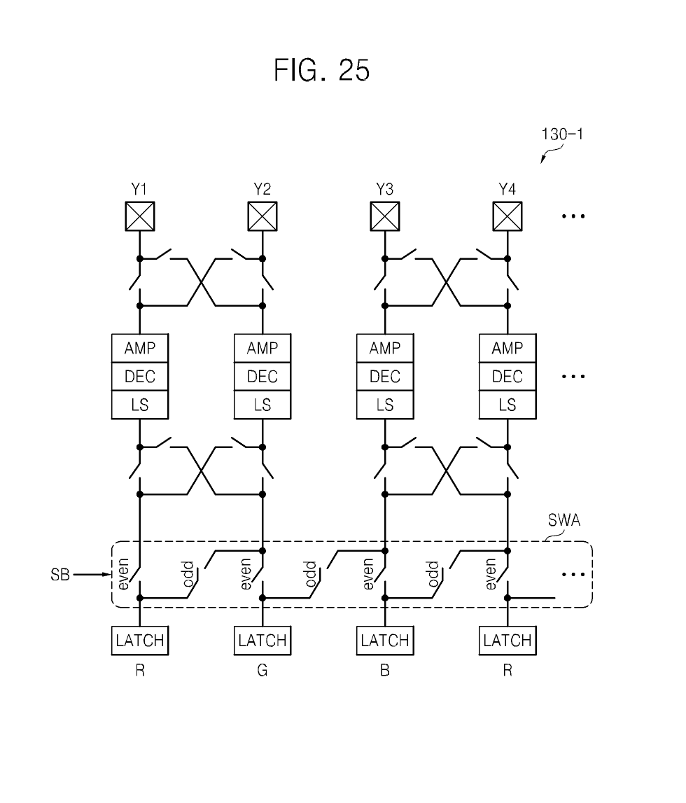

The compression code CPRS may include a bit only that indicates compression or non-compression. Alternatively, the compression code CPRS may include two or more bits that indicate both compression or non-compression and a compression method or algorithm. As another alternatively, the compression code CPRS may include multiple bits that contain an indication of compression or non-compression, a compression algorithm, and additional information (e.g., information about a switch signal SB in FIG. 25).

Hereinafter, to keep the description straightforward for the sake of clarity, it is assumed that the compression code CPRS includes two bits that indicate both compression or non-compression and a compression algorithm. The related data DATA may be the current line data, part of the current line data necessary for compression, or compressed current line data.

The data generation circuit 113-7A may generate the transmission data packet DIN, in which the clock signal CLK may be embedded, by using the compression code CPRS, the clock signal CLK, and the related data DATA.

A transmitter 115A, an example of the transmitter 115, may convert the transmission data packet DIN into differential signals in response to the clock signal CLK and may transmit the differential signals to the source driver IC 130-1 through channels 101. At this time, the channels 101 may be media, e.g., signal lines, that may transmit differential signals.

Each of the source driver ICs 130-1 through 130-S may have substantially the same structure as one another. Thus, the structure and the operations of the source driver IC 130-1 is described. The source driver IC 130-1 may include a receiver analog front end (RXAFE) 131, a clock signal-data recovery (CDR) circuit 133, and a logic circuit and driving block 137.

The RXAFE 131 may recover the transmission data packet DIN from the differential signals received through the channels 101. The CDR circuit 133 may generate a plurality of recovery clock signals CK by using one of a voltage-controlled delay line (VCDL) and a voltage-controller oscillator (VCO), which may be included, for example, in a clock signal recovery circuit 135, in response to a selection signal, i.e., a sleep mode enable signal SLP.

The logic circuit and driving block 137 may interpret the compression code CPRS contained in a delayed data packet DDATA output through the CDR circuit 133, may generate the sleep mode enable signal SLP according to an interpretation result, and may recover data transmitted from the timing controller 110 by using the recovery clock signals CK generated by the CDR circuit 133.

The logic circuit and driving block 137 may drive the recovered data to the display panel 150. In other words, the logic circuit and driving block 137 may perform both a function of a logic circuit that recovers the data transmitted from the timing controller 110 by using the recovery clock signals CK output from the CDR circuit 133 and a function of a driving block that drives the recovered data to the display panel 150.

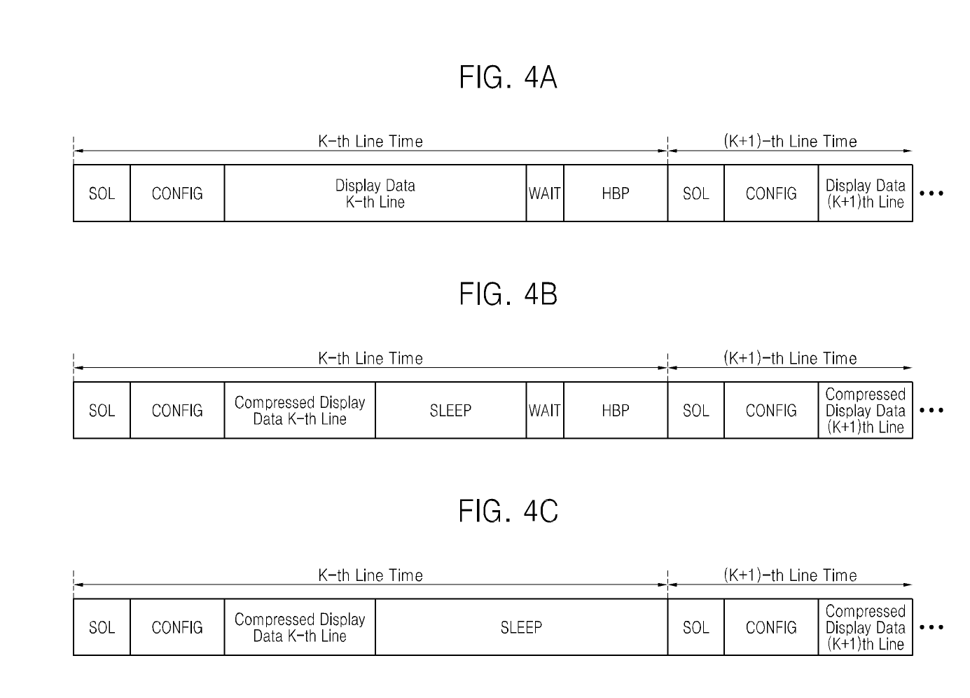

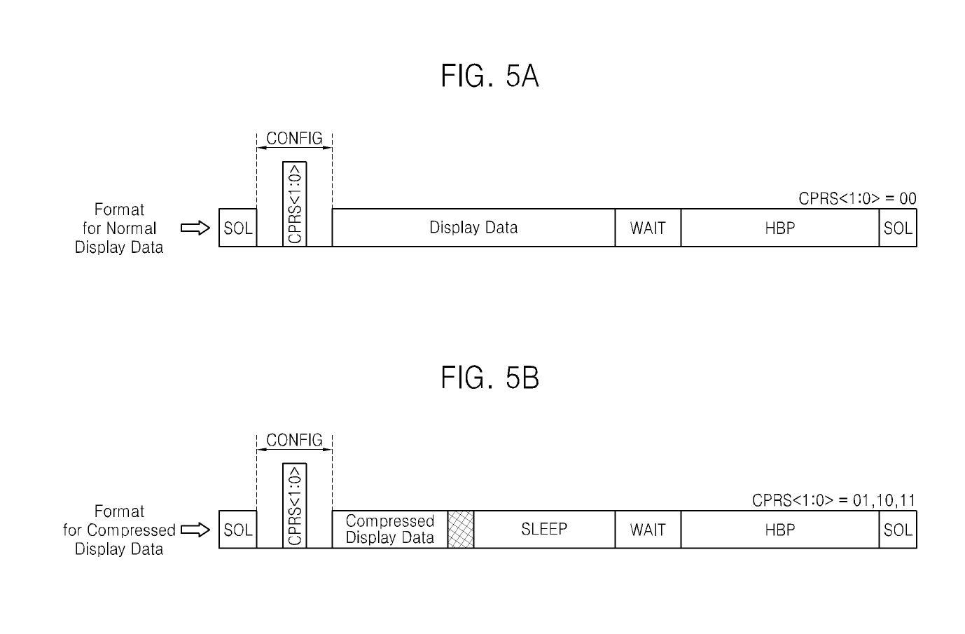

FIGS. 4A through 4C are diagrams that illustrate data packets according to an embodiment of the present inventive concept. FIGS. 5A and 5B are diagrams illustrating data packets that include the compression code CPRS according to an embodiment of the present inventive concept.

FIG. 4A illustrates an example of a data packet generated by a conventional timing controller. FIG. 4B illustrates an example of the data packet generated by the timing controller 110. FIG. 4C illustrates another example of the data packet generated by the timing controller 110.

Referring to FIGS. 4A through 4C, a first field SOL may be a start-of-line field that includes a notification pattern of the start of data transmission. A second field CONFIG may be a configuration field that includes packet configuration data. The compression code CPRS may be contained in the second field CONFIG.

A third field may be a compressed display data field that includes compressed display data. A fourth field WAIT may be a wait field provided for receiver latency. A fifth field SLEEP may be a sleep status field and may not contain data. The sleep data may be transmitted during the fifth field SLEEP. Accordingly, the fifth field and the sleep data may be both denoted by SLEEP. A sixth field HBP may be a blank time field, e.g., a horizontal blank period, and may indicate the end of the display data.

The transmission data packet DIN may selectively include the fourth field WAIT and the sixth field HBP. The transmission data packets DIN illustrated in FIGS. 4B and 4C may be examples. As shown in FIGS. 4A through 4C, the data packets may have the same line time, i.e., the same K-th line time.

FIG. 5A illustrates an example of a data packet format for normal display data. The data packet illustrated in FIG. 4A may correspond to the data packet format illustrated in FIG. 5A. FIG. 5B illustrates an example of a data packet format for compressed display data. The transmission data packet DIN illustrated in FIG. 4B may correspond to the data packet format illustrated in FIG. 5B.

The second field CONFIG may contain a compression code CPRS<1:0>. The compression code CPRS<1:0> of 2b′00 may indicate, for example, the transmission of a data packet that includes normal display data, i.e., uncompressed current line data. The compression code CPRS<1:0> of 2b′01 may indicate, for example, the transmission of a data packet that includes display data that has been compressed by using a first compression algorithm, e.g., changed pixel information encoding (CPIE).

The compression code CPRS<1:0> of 2b′10 may indicate, for example, the transmission of a data packet that includes display data that has been compressed by using a second compression algorithm, e.g., run length encoding (RLE).

The compression code CPRS<1:0> of 2b′11 may indicate, for example, the transmission of a data packet that includes display data that has been compressed by using a third compression algorithm, e.g., a combination of CPIE and RLE.

The three mentioned compression algorithms may be examples. Algorithms that compress current line data may be selected, for example, at a manufacturer's option. According to the compression code CPRS<1:0>, the data generation circuit 113-7A may generate the transmission data packet DIN that includes uncompressed current line data or the transmission data packet DIN that includes data that has been compressed by using an algorithm selected from a plurality of compression algorithms.

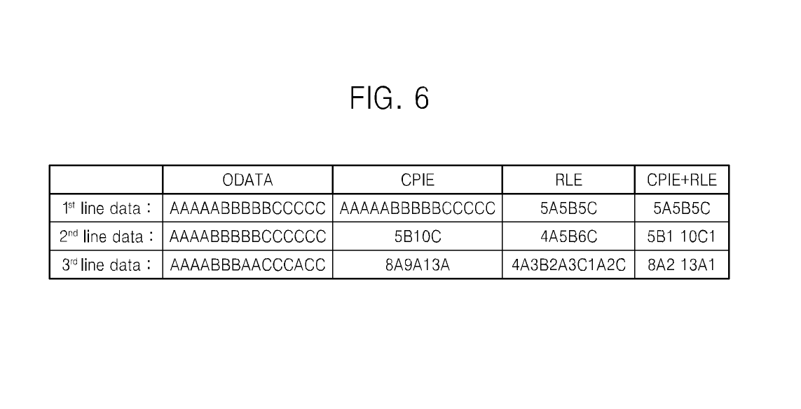

FIG. 6 is a diagram that illustrates compression algorithms according to an embodiment of the present inventive concept.

Referring to FIG. 6, when first line data is “AAAAABBBBBCCCCC”, the data generation circuit 113-7A may output “AAAAABBBBBCCCCC” according to CPIE. When second line data is “AAAABBBBBCCCCCC”, the data generation circuit 113-7A may output “5B10C” according to CPIE.

In other words, when the first line data is compared with the second line data, “5B10C” may indicate that a fifth pixel datum is changed into “B” and a tenth pixel datum is changed into C. “8A2 13A1”, generated according to the combination of CPIE and RLE, may indicate that two pixel data starting from an eighth pixel datum are changed into A and one pixel datum starting from a thirteenth pixel datum is changed into A.

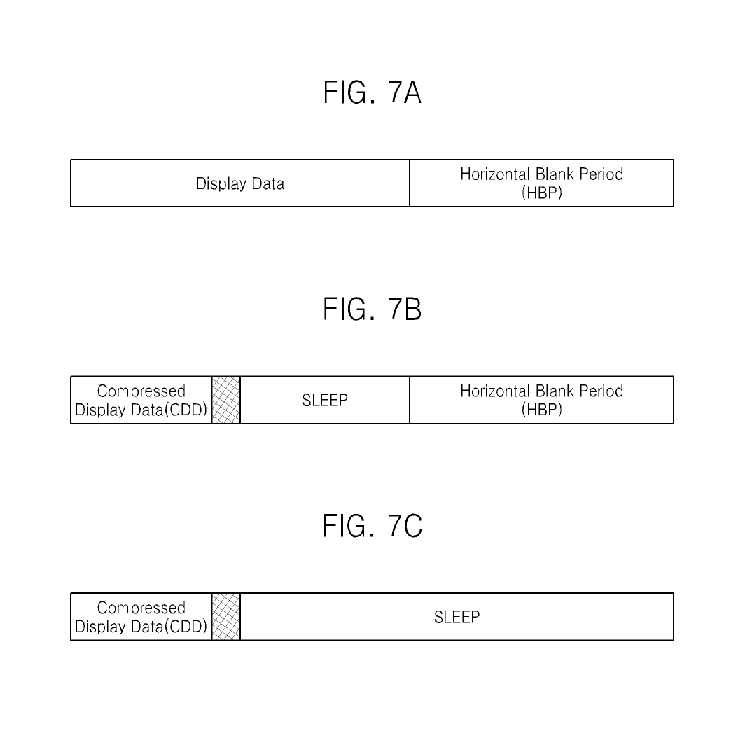

FIGS. 7A through 7C are diagrams that illustrate data packets according to various embodiments of the present inventive concept. FIG. 7A illustrates an example of a transmission data packet DIN that includes uncompressed display data. The transmission data packet DIN may include, for example, the uncompressed display data and a horizontal blank period HBP.

FIG. 7B illustrates an example of a transmission data packet DIN that includes compressed display data CDD and the sleep data SLEEP. The transmission data packet DIN may include, for example, the compressed display data CDD, the sleep data SLEEP, and the horizontal blank period HBP.

FIG. 7C illustrates another example of the transmission data packet DIN that includes the compressed display data CDD and the sleep data SLEEP. The transmission data packet DIN may include, for example, the compressed display data CDD and the sleep data SLEEP.

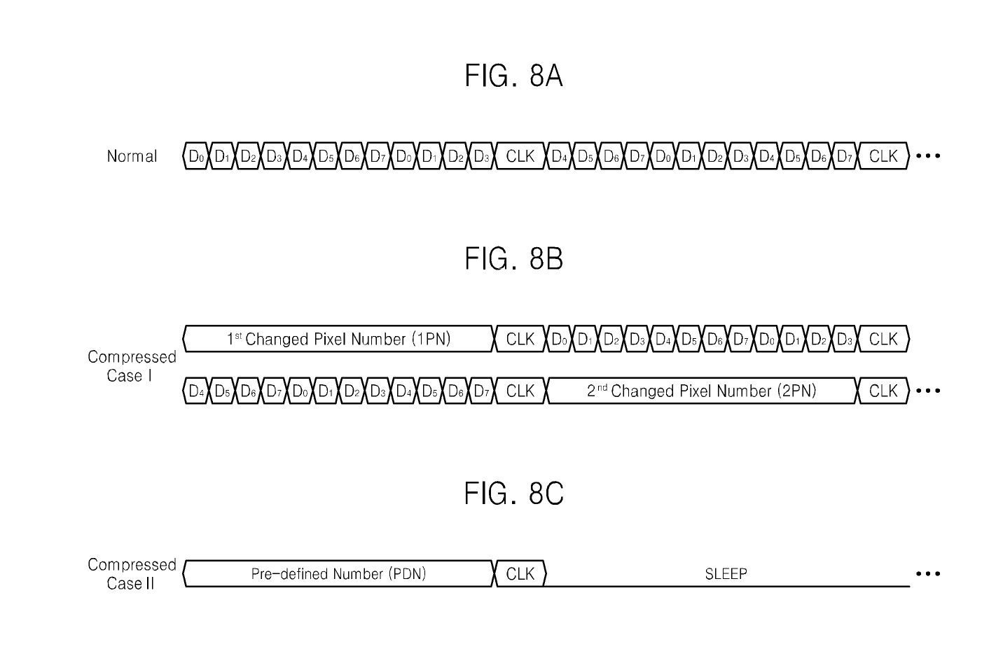

FIGS. 8A through 8C are diagrams that illustrate transmission data packets DIN according to various embodiments of the present inventive concept.

FIG. 8A illustrates an example of a normal transmission data packet DIN that includes the clock signal CLK and display data. The display data may include, for example, 24-bit RGB pixel data. 12-bit data may be inserted, for example, between two adjacent clock signals CLK. For example, a first eight bits may be red (R) pixel data, a second eight bits may be green (G) pixel data, and a third eight bits may be blue (B) pixel data.

FIG. 8B illustrates an example of a transmission data packet DIN that includes a number of a changed pixel detected based on a result of comparing previous line data with current line data and pixel data of a pixel. In other words, FIG. 8B illustrates the transmission data packet DIN when only part of the current line data is different from the previous line data.

For example, when only pixel data of the 30th and 50th pixels in the current line data are changed as compared with the previous line data, the logic circuit 113 may generate a transmission data packet DIN that includes numbers 1 PN and 2PN of the respective changed pixels and the pixel data of the respective pixels. Accordingly, the current line data may be compressed.

Referring to FIG. 8C, when the previous line data is completely the same as the current line data, the logic circuit 113 may generate, for example, the transmission data packet DIN that includes a predefined number PDN, the clock signal CLK, and the sleep data SLEEP. Accordingly, the current line data may be compressed.

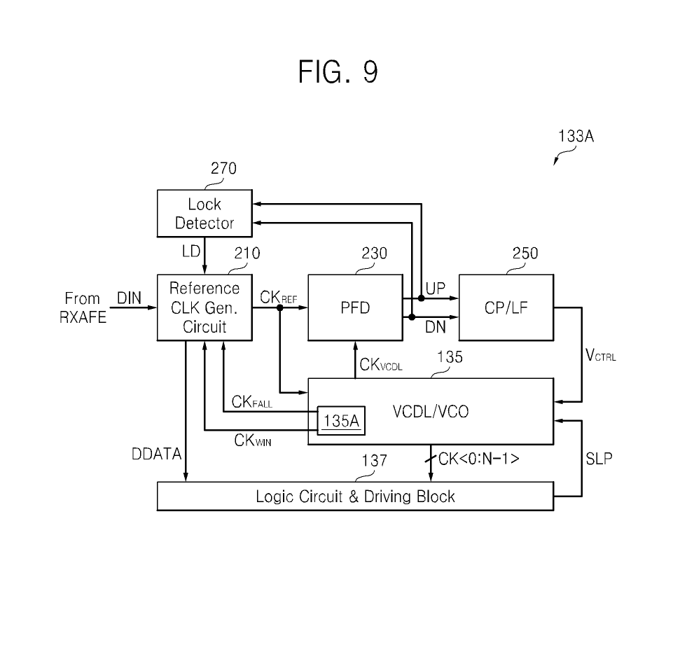

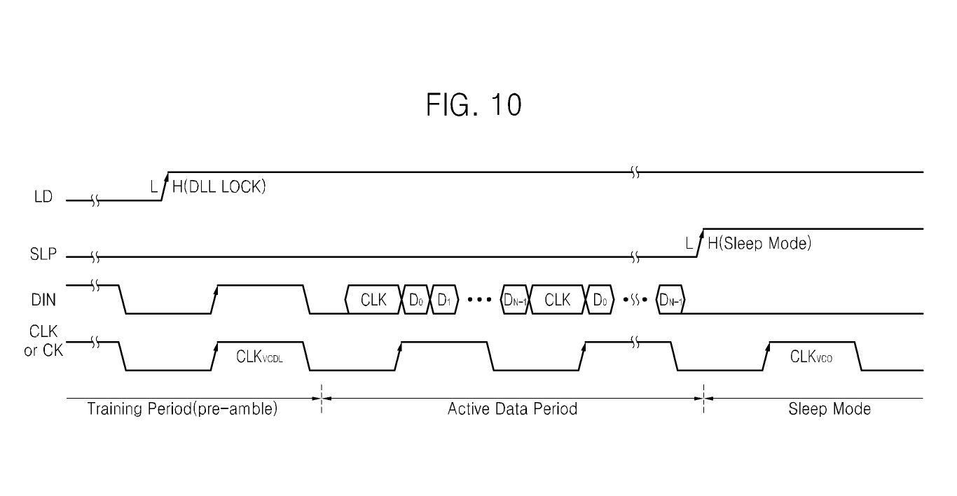

FIG. 9 is a schematic block diagram that illustrates a clock signal-data recovery (CDR) circuit 133A according to an embodiment of the present inventive concept. FIG. 10 is a timing chart that illustrates an example of an operation of the CDR circuit 133A illustrated in FIG. 9.

Referring to FIGS. 2 and 9, the CDR circuit 133A may be an example of the CDR circuit 133 illustrated in FIG. 2. The CDR circuit 133A may include a reference clock generation circuit 210, a phase-frequency detector (PFD) 230, a control voltage generation circuit 250, a lock detector 270, and the clock signal recovery circuit 135. Hereinafter, to facilitate the description for the sake of clarity, the logic circuit and driving block 137 is illustrated together with the CDR circuit 133A, 133B, 133C, and 133D, respectively, in FIGS. 9, 15, 16, and 17.

The reference clock generation circuit 210 may delay the transmission data packet DIN and may transmit the delayed data packet DDATA to the logic circuit and driving block 137. The reference clock generation circuit 210 also may output the clock signal CLK included in the transmission data packet DIN as a reference clock signal CK_{REF} in response to a lock detection signal LD being at a low level.

In response to the lock detection signal LD being at a high level, the reference clock generation circuit 210 may generate the reference clock signal CK_{REF} by using the clock signal CLK included in the transmission data packet DIN, a window signal CK_{WIN}, and a falling edge control signal CK_{FALL}.

For example, the reference clock generation circuit 210 may detect a falling edge of a complementary clock signal by using the window signal CK_{WIN}. The complementary clock signal may be a clock signal complementary to the clock signal CLK. Alternatively, the reference clock generation circuit 210 may detect a rising edge or a falling edge of the clock signal CLK by using the window signal CK_{WIN}.

The reference clock generation circuit 210 may generate the reference clock signal CK_{REF}, which may rise in response to the falling edge of the complementary clock signal, and may generate the reference clock signal CK_{REF}, which may fall in response to a rising edge of the falling edge control signal CK_{FALL}.

The PFD 230 may compare the phase and the frequency of the reference clock signal CK_{REF} with the phase and the frequency of an output clock signal CK_{VCDL} output from the clock signal recovery circuit 135 and may generate a first control signal UP and/or a second control signal DN according to a comparison result.

The control voltage generation circuit 250 may output a control voltage V_{CTRL} in response to the first control signal UP and/or the second control signal DN.

A charge pump/loop filter (CP/LF) may be used, for example, as the control voltage generation circuit 250. The CP/LF 250 may output the control voltage V_{CTRL} that has an increased level in response to the first control signal UP and may output the control voltage V_{CTRL} that has a decreased level in response to the second control signal DN.

In other words, the charge pump (CP) may output the control voltage V_{CTRL} that has an adjusted level in response to the first control signal UP or the second control signal DN. The loop filter (LF) may perform low-pass filtering on the control voltage V_{CTRL} and may output the low-pass filtered control voltage V_{CTRL}.

The lock detector 270 may generate the lock detection signal LD that indicates locked or unlocked status in response to the first control signal UP and/or the second control signal DN. For example, the lock detector 270 may generate the lock detection signal LD at a high level when a delay locked loop (DLL) is locked.

The clock signal recovery circuit 135 includes the voltage-controlled delay line (VCDL), the voltage-controller oscillator (VOC), and a control signal generator 135A that generates the window signal CK_{WIN} and the falling edge control signal CK_{FALL}.

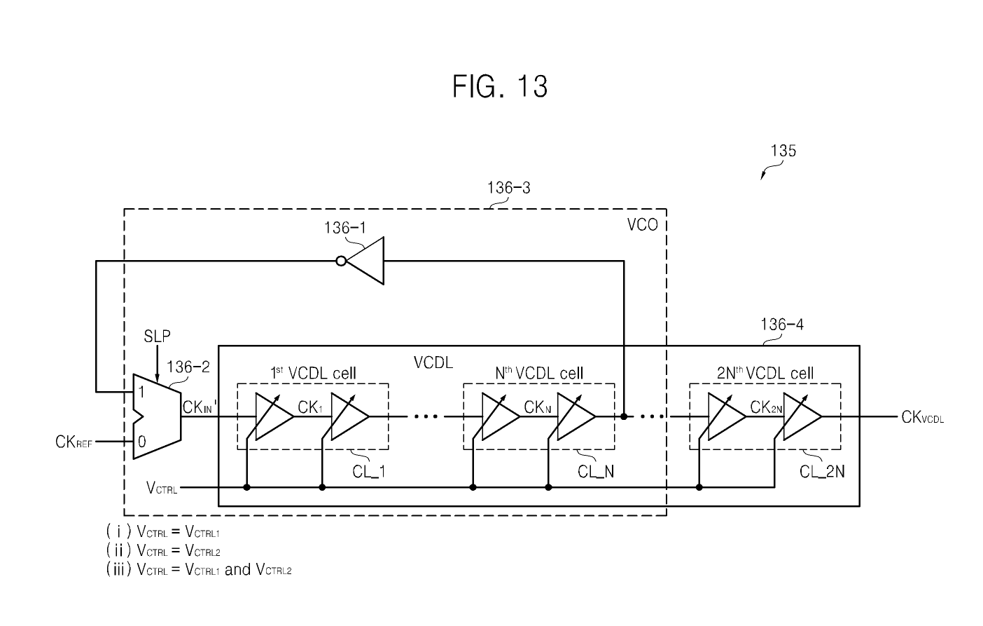

Referring to FIGS. 10 and 13, the clock signal recovery circuit 135 may generate the recovery clock signals CK by using the VCDL 136-4 when the sleep mode enable signal SLP is at a low level and may generate the recovery clock signals CK by using the VCO 136-3 when the sleep mode enable signal SLP is at a high level.

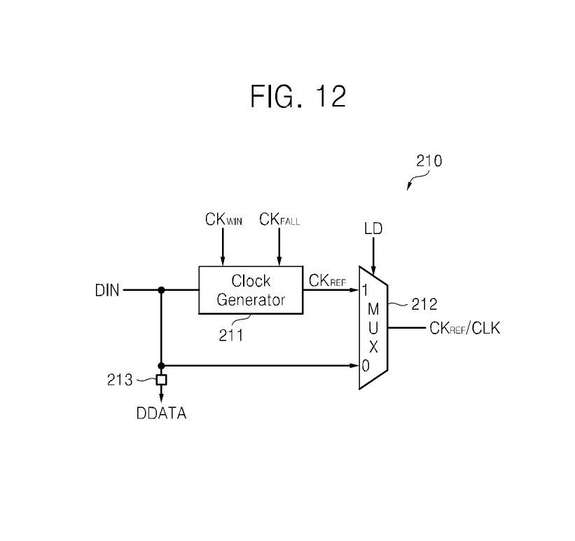

FIG. 12 is a schematic block diagram that illustrates an example of the reference clock generation circuit 210 illustrated in FIG. 9. Referring to FIG. 12, the reference clock generation circuit 210 may include a clock generator 211, a selection circuit 212, and a delay circuit 213.

The clock generator 211 may generate the reference clock signal CK_{REF} by using the clock signal CLK included in the transmission data packet DIN, the window signal CK_{WIN}, and the falling edge control signal CK_{FALL}.

The selection circuit 212 may output the clock signal CLK included in the transmission data packet DIN or the reference clock signal CK_{REF} in response to the lock detection signal LD.

The delay circuit 213 may delay the transmission data packet DIN and may transmit the delayed data packet DDATA to the logic circuit and driving block 137.

FIG. 13 is a circuit diagram that illustrates an example of the clock signal recovery circuit 135 illustrated in FIG. 9. The clock signal recovery circuit 135 may include an inverter 136-1, a selection circuit 136-2, and a plurality of VCDL cells CL_{—1} through CL_{—2N.}

The inverter 136-1 may form a feedback loop to construct the VCO 136-3. In other words, when the sleep mode enable signal SLP is at the low level, the VCDL 136-4 may generate recovery clock signals CK₁ through CK_{2N} by using the VCDL cells CL_{—1} through CL_{—2N.}

However, when the sleep mode enable signal SLP is at the high level, the VCO 136-3 may generate the recovery clock signals CK₁ through CK_{N} by using the inverter 136-1 and the VCDL cells CL_{—1} through CL_N.

The VCDL cells CL_{—1} through CL_N may be shared by the VCDL 136-4 and the VCO 136-3. In other words, when the sleep mode enable signal SLP is at the low level, the clock signal recovery circuit 135 may operate in a VCDL mode in which the clock signal recovery circuit 135 may generate the recovery clock signals CK₁ through CK_{2N} using the VCDL 136-4.

When the sleep mode enable signal SLP is at the high level, the clock signal recovery circuit 135 may operate in a VCO mode in which the clock signal recovery circuit 135 may generates the recovery clock signals CK₁ through CK_{N} using the VCO 136-3.

The selection circuit 136-2 may output the reference clock signal CK_{REF} or an output signal of the inverter 136-1 in response to the sleep mode enable signal SLP. The VCDL 136-4 may generate the recovery clock signals CK₁ through CK_{2N} so that each of the recovery clock signals CK₁ through CK_{2N} has a different phase from each other in response to an output signal CK_{IN} of the selection circuit 136-2 and the control voltage V_{CTRL}. A delay time t_{D} between two adjacent recovery clock signals may be constant.

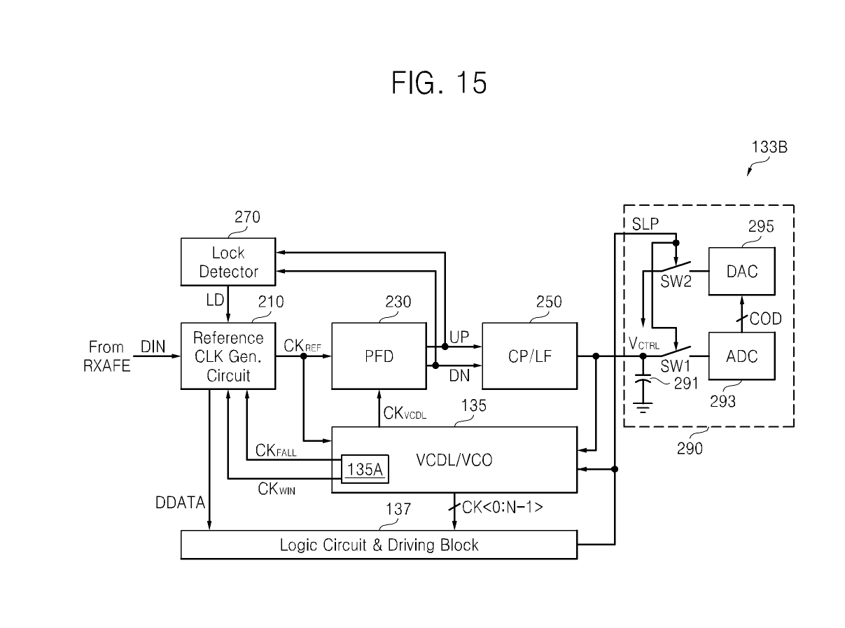

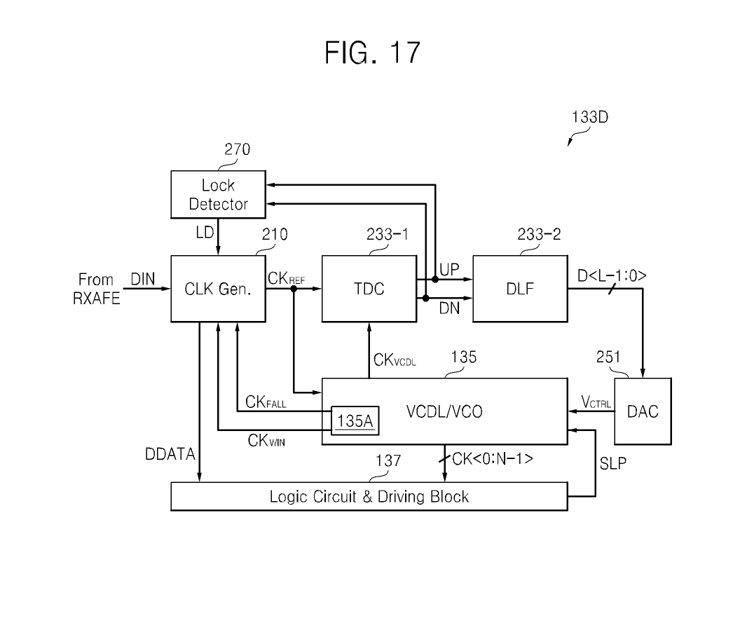

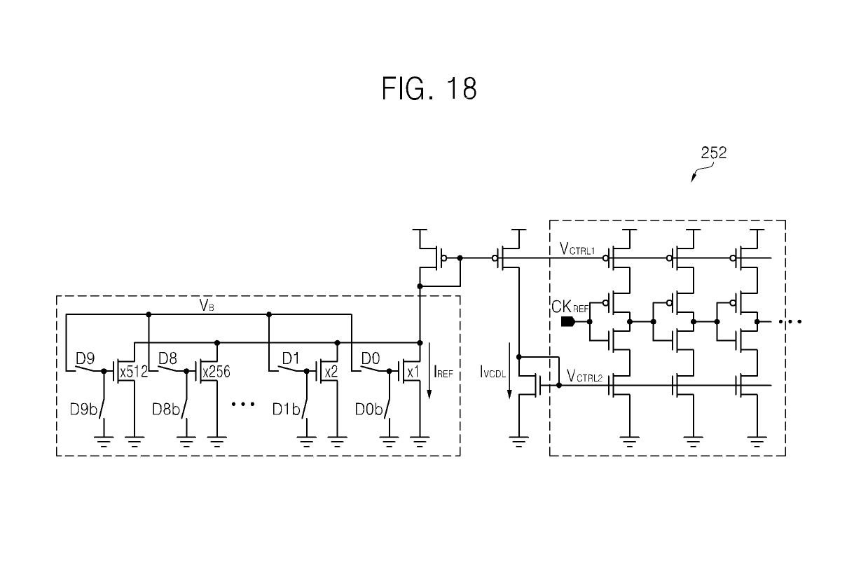

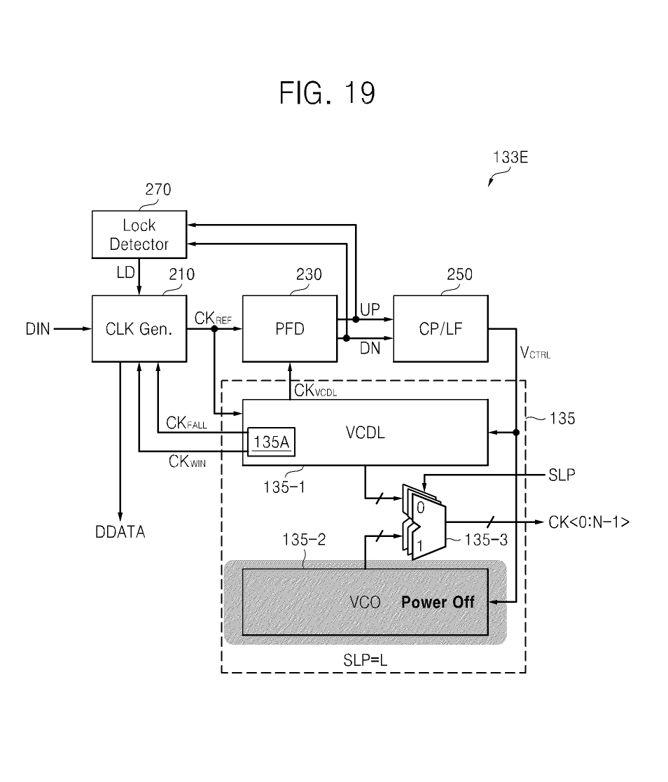

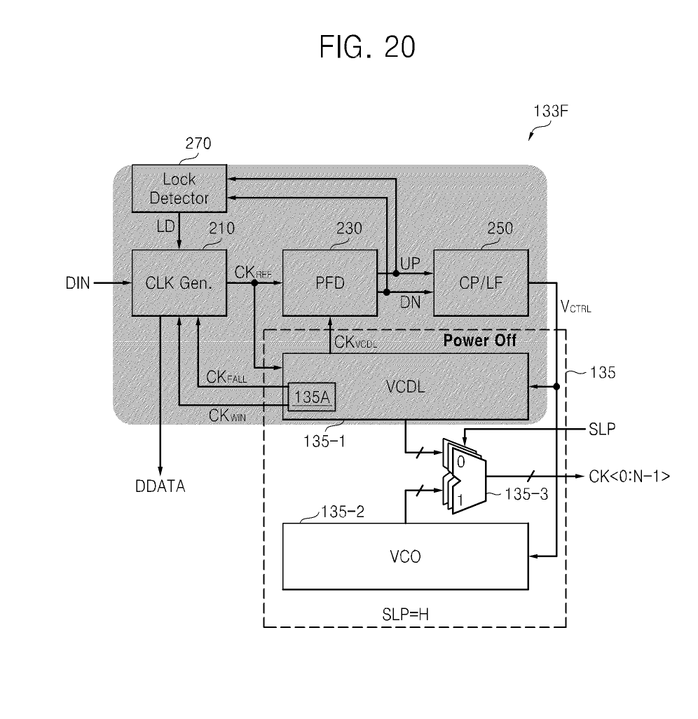

FIGS. 15 through 17 are schematic block diagrams that illustrate, respectively, the CDR circuits 133B, 133C, and 133D according to various embodiments of the present inventive concept. FIG. 18 is a circuit diagram that illustrates an example of the digital-to-analog converter (DAC) 252 illustrated in FIG. 17. FIGS. 19 and 20 are schematic block diagrams that illustrate, respectively, CDR circuits 133E and 133F according to various embodiments of the present inventive concept.

Referring to FIGS. 9 and 15, except for a control voltage maintaining circuit 290, the structure and the operation of the CDR circuit 133B may be substantially the same as those of the CDR circuit 133A. The control voltage maintaining circuit 290 may prevent the control voltage V_{CTRL} from drifting when the clock signal recovery circuit 135 operates in the VCO mode. The control voltage maintaining circuit 290 may include a capacitor 291, an analog-to-digital converter (ADC) 293, a digital-to-analog converter (DAC) 295, and a plurality of switches SW1 and SW2.

When the sleep mode enable signal SLP is at the high level, the switches SW1 and SW2 may be closed. Accordingly, the ADC 293 may convert the control voltage V_{CTRL} at the capacitor 291 into a digital code COD and the DAC 295 may convert the digital code COD into the control voltage V_{CTRL}. Therefore, when the clock signal recovery circuit 135 operates in the VCO mode, the control voltage V_{CTRL} may be maintained at a certain level by the control voltage maintaining circuit 290.

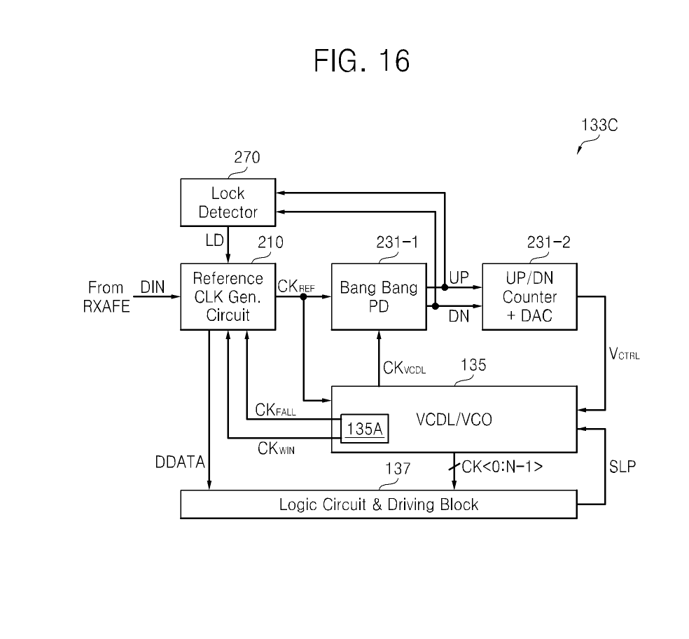

Referring to FIGS. 9 and 16, except for a bang-bang phase detector (PD) 231-1 and a control voltage supply circuit 231-2, the structure and the operation of the CDR circuit 133C may be substantially the same as those of the CDR circuit 133A.

The bang-bang PD 231-1 may receive the reference clock signal CK_{REF} and the output clock signal CK_{VCDL} of the clock signal recovery circuit 135. The control voltage supply circuit 231-2 may generate a count value in response to at least one of the first control signal UP and the second control signal DN output from the bang-bang PD 231-1, may generate the control voltage V_{CTRL} based on the count value, and may supply the control voltage V_{CTRL} to the clock signal recovery circuit 135.

The control voltage supply circuit 231-2 may include, for example, an up/down counter (UP/DN counter) and a digital-to-analog converter (DAC). The up/down counter may generate the count value in response to the at least one of the first control signal UP and the second control signal DN output from the bang-bang PD 231-1. The DAC may generate the control voltage V_{CTRL} based on the count value and may supply the control voltage V_{CTRL} to the clock signal recovery circuit 135.

The control voltage supply circuit 231-2, including the up/down counter and the DAC, may function as a control voltage maintaining circuit that maintains the control voltage V_{CTRL} at a certain level when the clock signal recovery circuit 135 operates in the VOC mode. The DAC may be implemented, for example, by the DAC 252 illustrated in FIG. 18 and may generate the control voltage V_{CTRL} based on the reference clock signal CK_{REF} and the count value.

Referring to FIGS. 9 and 17, except for a time-to-digital converter (TDC) 233-1, a digital loop filter (DLF) 233-2, and the control voltage supply circuit 251, the structure and the operation of the CDR circuit 133D may be substantially the same as those of the CDR circuit 133A. The TDC 233-1 may receive the reference clock signal CK_{REF} and the output clock signal CK_{VCDL} of the clock signal recovery circuit 135. The DLF 233-2 may be connected to the TDC 233-1. The DLF 233-2 may generate a digital code D<L−1:0> in response to at least one of the first control signal UP and the second control signal DN output from the TDC 233-1.

The control voltage supply circuit 251 may generate the control voltage V_{CTRL} based on the digital code D<L−1:0> output from the DLF 233-2 and may supply the control voltage V_{CTRL} to the clock signal recovery circuit 135. The control voltage supply circuit 251 may be implemented, for example, by the DAC 252 illustrated in FIG. 18. The DAC 252 may generate the control voltage V_{CTRL} based on the data DATA included in the transmission data packet DIN and the digital code D<L−1:0>. The control voltage supply circuit 251 may function as a control voltage maintaining circuit that maintains the control voltage V_{CTRL} at a certain level when the clock signal recovery circuit 135 operates in the VOC mode.

Referring to FIG. 18, the DAC 252 may output the control voltage V_{CTRL} based on the data DATA included in the transmission data packet DIN and the digital code D<L−1:0>. FIG. 18 illustrates a 10-bit DAC 252 as an example. Reference characters DY (Y=0, 1, 2, . . . 9) and DYb, respectively, may denote complementary signals. A reference character V_{B} may denote an operating voltage supplied to transistors x1 through x512. The transistors x1 through x512 may have a weighted size. A reference current I_{REF} may be controlled based on bits D0 through D9.

The reference current I_{REF} may be mirrored as a mirror current I_{VCDL} by a current mirror. A first voltage control signal V_{CTRL1} may be generated from the reference current I_{REF} and a second voltage control signal V_{CTRL2} may be generated from the mirror current I_{VCDL}. The control voltage V_{CTRL} may include the first voltage control signal V_{CTRL1} and/or the second voltage control signal V_{CTRL2}.

Referring to FIGS. 9 and 19, the clock signal recovery circuit 135 may include a voltage-controlled delay line (VCDL) 135-1 and a voltage-controller oscillator (VCO) 135-2, which may be separated from each other, and a selection circuit 135-3. When the sleep mode enable signal SLP is at the low level, the VCO 135-2 may be powered off.

When the sleep mode enable signal SLP is at the low level, the clock signal recovery circuit 135 may generate recovery clock signals CK<0:N−1> by using the VCDL 135-1. In other words, the selection circuit 135-3 may output the recovery clock signals CK<0:N−1> generated by the VCDL 135-1 in response to the sleep mode enable signal SLP at the low level.

Referring to FIGS. 9 and 20, the clock signal recovery circuit 135 may include the VCDL 135-1 and the VCO 135-2, which may be separated from each other, and the selection circuit 135-3. When the sleep mode enable signal SLP is at the high level, the elements 135A, 135-1, 210, 230, 250, and 270 may be powered off.

When the sleep mode enable signal SLP is at the high level, the clock signal recovery circuit 135 may generate recovery clock signals CK<0:N−1> by using the VCO 135-2. In other words, the selection circuit 135-3 may output the recovery clock signals CK<0:N−1> generated by the VCO 135-2 in response to the sleep mode enable signal SLP at the high level.

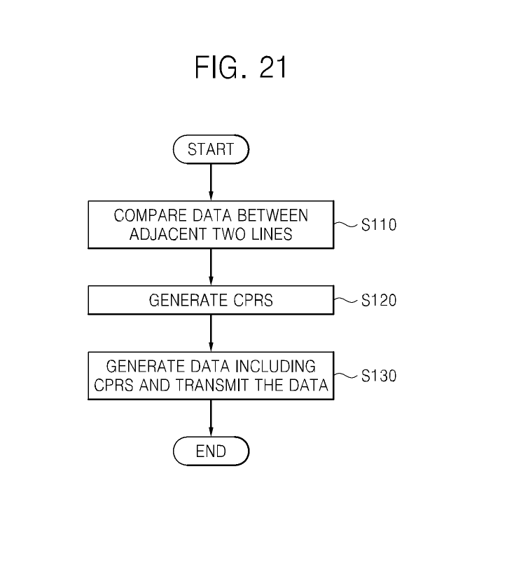

FIG. 21 is a flowchart that illustrates an operation of the timing controller 110 according to an embodiment of the present inventive concept. Referring to FIGS. 1 through 8C and 21, the timing controller 110, in an operation S110, may compare line data between two adjacent lines. For example, the timing controller 110 may compare previous line data with current line data.

The timing controller 110, in an operation S120, may generate the compression code CPRS that indicates the compression or non-compression of the current line data. The timing controller 110, in an operation S130, may generate the transmission data packet DIN that includes the compression code CPRS, compressed data, and the sleep data SLEEP and may transmit the transmission data packet DIN through the transmitter 115.

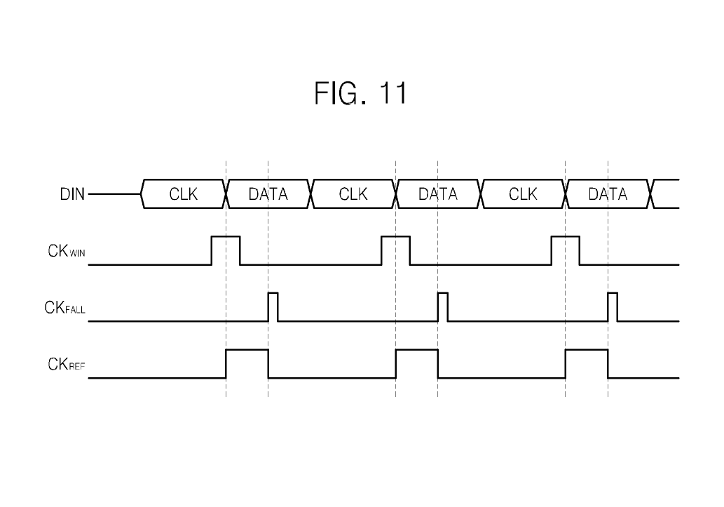

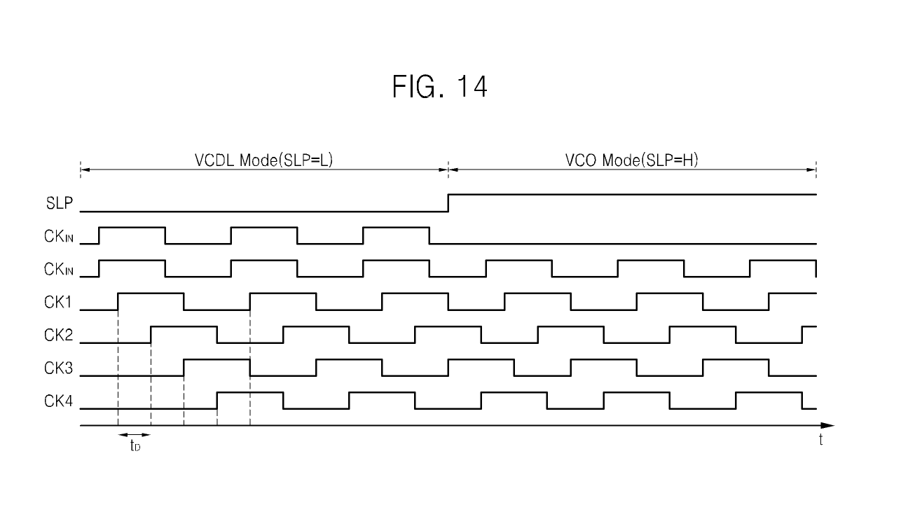

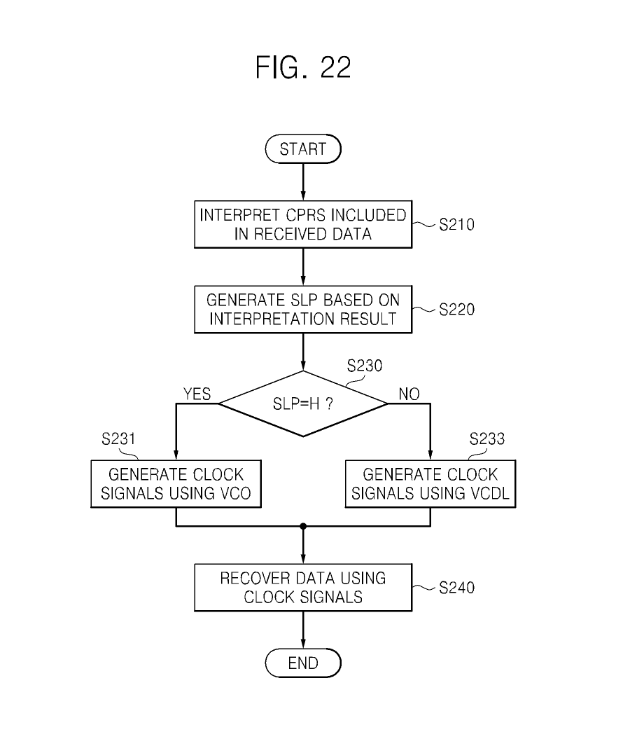

FIG. 22 is a flowchart that illustrates an operation of the CDR circuit 133 and the logic circuit and driving block 137 according to an embodiment of the present inventive concept. Referring to FIGS. 1, 2, 9 through 20, and 22, the logic circuit and driving block 137, in an operation S210, may receive the transmission data packet DIN, which may include the data, the compression code CPRS, and the clock signal CLK, and may interpret the compression code CPRS.

The logic circuit and driving block 137, in an operation S220, may generate the sleep mode enable signal SLP based on an interpretation result. The CDR circuit 133, in an operation S230, may determine a level of the sleep mode enable signal SLP.

When the sleep mode enable signal SLP is at the high level, the clock signal recovery circuit 135, in an operation S231, may operate in the VCO mode and thus may generate the recovery clock signals CK by using the VCO 136-3. When the sleep mode enable signal SLP is at the low level, the clock signal recovery circuit 135, in an operation S233, may operate in the VCDL mode and thus may generate the recovery clock signals CK using the VCDL 136-4.

The logic circuit and driving block 137, in an operation S240, may recover the data included in the transmission data packet DIN using the recovery clock signals CK. The logic circuit and driving block 137 may drive the display panel 150 using the recovered data.

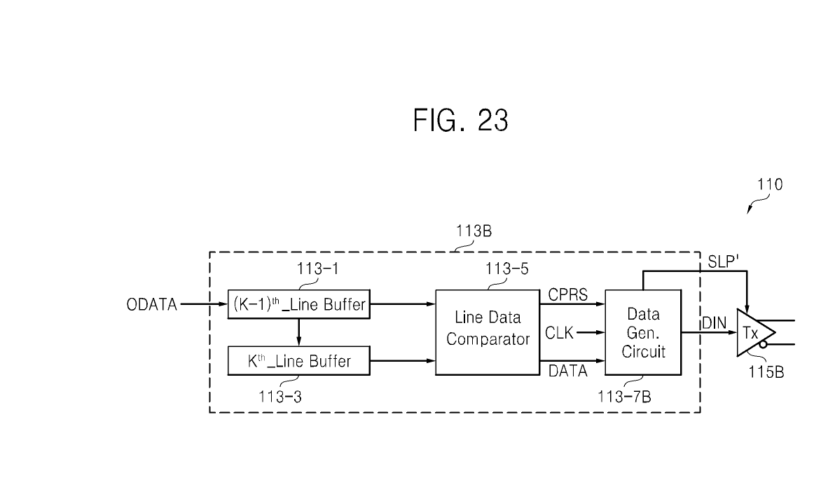

FIG. 23 is a schematic block diagram that illustrates the timing controller 110 according to an embodiment of the present inventive concept. Referring to FIGS. 2, 3, and 23, a logic circuit 113B may include the first line buffer 113-1, the second line buffer 113-3, the line data comparator 113-5, and a data generation circuit 113-7B.

The data generation circuit 113-7B may generate a transmitter sleep mode enable signal SLP′ based on the compression code CPRS. A transmitter 115B may be enabled or disabled in response to the transmitter sleep mode enable signal SLP′. When sleep data is output, the transmitter 115B may be disabled in response to the transmitter sleep mode enable signal SLP′.

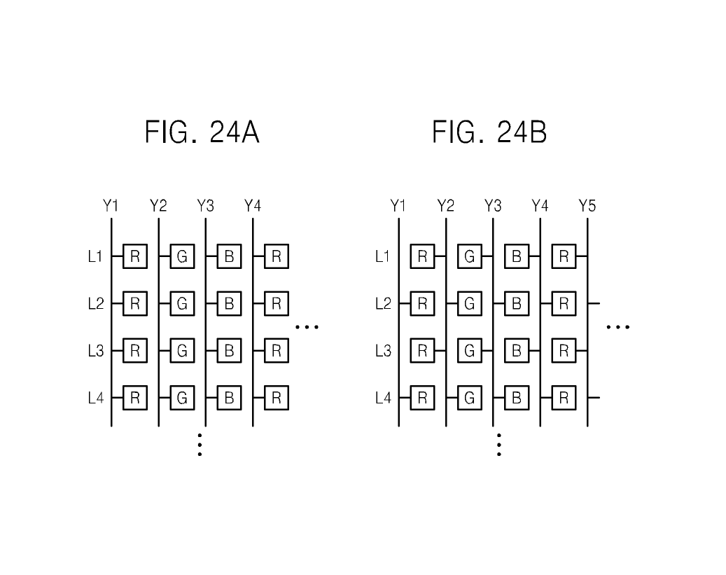

FIGS. 24A and 24B are diagrams that illustrate examples of the pixel structures of the display panel 150 illustrated in FIG. 1. FIG. 24A illustrates an example of the pixel structure of the display panel 150 in which pixels may be arranged in a strip pattern. In FIG. 24A, Y1 through Y4 may denote data lines, L1 through L4 may denote scan lines, R may denote a red (R) pixel, G may denote a green (G) pixel, and B may denote a blue (B) pixel. FIG. 24B illustrates an example of the pixel structure of the display panel 150 in which pixels may be arranged in a zigzag pattern. In FIG. 24B, Y1 through Y5 may denote data lines and L1 through L4 may denote scan lines.

FIG. 25 is a schematic diagram that illustrates an example of a driver cell array of the source driver IC 130-1 illustrated in FIG. 1. When current line data is compressed by using changed pixel information encoding (CPIE) and the pixel structure of the display panel 150 has the zigzag pattern, the driver cell array of the source driver IC 130-1 may have the structure illustrated in FIG. 25 to drive the data compressed by using the CPIE.

As shown in FIG. 25, the driver cell array of the source driver IC 130-1 may include a switch array SWA. Switches “even” and “odd” in the switch array SWA may be switched in response to the switch signal SB. The even-numbered switches “even” and the odd-numbered switches “odd” may operate complementarily to each other.

Information about the switch signal SB may be included in the compression code CPRS. In this case, the logic circuit and driving block 137 may interpret the information included in the compression code CPRS and may generate the switch signal SB based on an interpretation result.

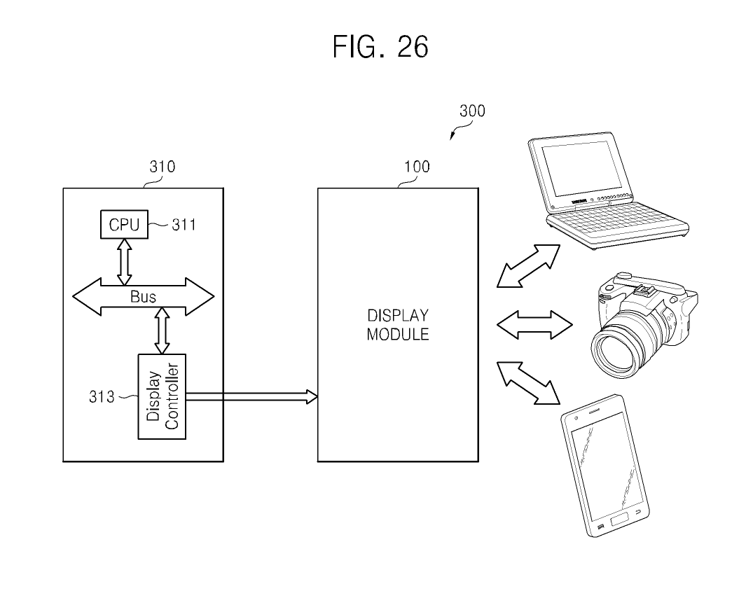

FIG. 26 is a block diagram that illustrates a display device 300 that includes the display module 100 according to an embodiment of the present inventive concept. Referring to FIGS. 1 through 26, the display device 300 may include a processor 310 and the display module 100.

The processor 310 may include, for example, a central processing unit (CPU) 311 and a display controller 313. The processor 311 may be implemented, for example, as an application processor or a mobile application processor.

The CPU 311 may control the operation of the display controller 313 through a bus. The display controller 313 may control the operation of the display module 100. For example, the display controller 313 may control an operation of the timing controller 110. The display device 300 may be implemented, for example, as a portable electronic device, which may signify mobile equipment. The portable electronic device may be, for example, a laptop computer, a mobile telephone, a smart phone, a tablet personal computer (PC), a personal digital assistant (PDA), an enterprise digital assistant (EDA), a digital still camera, a digital video camera, a portable multimedia player (PMP), a personal navigation device or portable navigation device (PND), a handheld game console, a mobile internet device (MID), or an e-book.

As described above, according to some embodiments of the present inventive concept, a timing controller may compare line data between two adjacent lines and may compress data to be transmitted based on a comparison result, thereby reducing the amount of data transmitted. As a result, the power consumption of the timing controller may be reduced.

In addition, a source driver IC selectively may operate a VCDL or a VCO according to a compression or non-compression of the data transmitted from the timing controller. The source driver IC may generate recovery clock signals using one of the VCDL and the VCO and may recover the data transmitted from the timing controller using the recovery clock signals. As a result, the power consumption of the source driver IC also may be reduced.

Although a few embodiments of the present general inventive concept have been shown and described, it will be appreciated by those of ordinary skill in the art that changes may be made in these embodiments without departing from the principles and spirit of the general inventive concept, the scope of which is defined in the appended claims and their equivalents.

1. A timing controller, comprising:
a logic circuit configured to compare previous line data with current line data, to compress the current line data based on a comparison result, and to generate a transmission data packet including a compression code indicating compression or non-compression of the current line data, compressed data, and sleep data; and
a transmitter configured to transmit the transmission data packet.

2. The timing controller of claim 1, wherein the logic circuit comprises:
a line data comparator configured to compare the previous line data with the current line data and to generate the compression code based on the comparison result; and
a data generation circuit configured to compress the current line data based on the compression code and to generate the transmission data packet.

3. The timing controller of claim 1, wherein the logic circuit is configured to generate the compressed data including a number of a changed pixel detected based on the comparison result and pixel data of a pixel.

4. The timing controller of claim 1, wherein the logic circuit is configured to generate a transmitter sleep mode enable signal when the sleep data is transmitted and the transmitter is disabled in response to the transmitter sleep mode enable signal.

5. A source driver integrated circuit (IC), comprising:
a logic circuit configured to receive a transmission data packet including data, a compression code indicating compression or non-compression of the data, and a clock signal, to interpret the compression code, and to generate a sleep mode enable signal based on an interpretation result; and
a clock signal recovery circuit configured to enable one of a voltage-controlled delay line and a voltage-controller oscillator in response to the sleep mode enable signal.

6. The source driver IC of claim 5, wherein the voltage-controlled delay line is configured to generate a plurality of first recovery clock signals in response to the sleep mode enable signal indicating non-compression of the data and the voltage-controller oscillator is configured to generate a plurality of second recovery clock signals in response to the sleep mode enable signal indicating compression of the data.

7. The source driver IC of claim 5, further comprising a control voltage maintaining circuit configured to supply a constant control voltage to the voltage-controller oscillator when the voltage-controller oscillator is enabled.

8. The source driver IC of claim 5, wherein the voltage-controller oscillator is configured to share a part of the voltage-controlled delay line.

9. The source driver IC of claim 8, further comprising:
a reference clock generation circuit configured to generate a reference clock signal based on the clock signal;
a phase-frequency detector configured to receive the reference clock signal and an output clock signal of the voltage-controlled delay line;
a control voltage generation circuit configured to generate a control voltage in response to at least one control signal output from the phase-frequency detector, the control voltage supplied to the voltage-controlled delay line; and
a control voltage maintaining circuit configured to maintain the control voltage constant in response to the sleep mode enable signal.

10. The source driver IC of claim 8, further comprising:
a reference clock generation circuit configured to generate a reference clock signal based on the clock signal;
a bang-bang phase detector configured to receive the reference clock signal and an output clock signal of the voltage-controlled delay line; and
a control voltage supply circuit configured to generate a count value in response to at least one control signal output from the bang-bang phase detector, to generate a control voltage based on the count value, and to supply the control voltage to the voltage-controlled delay line.

11. The source driver IC of claim 8, further comprising:
a reference clock generation circuit configured to generate a reference clock signal based on the clock signal;
a time-to-digital converter configured to receive the reference clock signal and an output clock signal of the voltage-controlled delay line;
a digital loop filter connected to the time-to-digital converter; and
a control voltage supply circuit configured to generate a control voltage based on a control code output from the digital loop filter and to supply the control voltage to the voltage-controlled delay line.

12. The source driver IC of claim 5, wherein the clock signal recovery circuit includes a selection circuit configured to output recovery clock signals of the voltage-controlled delay line or recovery clock signals of the voltage-controller oscillator in response to the sleep mode enable signal.

13. The source driver IC of claim 5, wherein the logic circuit is configured to recover display data from the data based on recovery clock signals output from one of the voltage-controlled delay line and the voltage-controller oscillator.

14. The source driver IC of claim 5, wherein:
the voltage-controlled delay line includes a plurality of voltage-controlled delay line cells connected in series;
the clock signal recovery circuit includes:
an inverter configured to receive an output signal of one of the voltage-controlled delay line cells; and
a selection circuit configured to apply one of a reference clock signal generated based on the clock signal and an output signal of the inverter to a first voltage-controlled delay line cell in response to the sleep mode enable signal; and
the voltage-controller oscillator includes some of the voltage-controlled delay line cells and the inverter.

15. A display device, comprising:
a display panel; and
a source driver integrated circuit (IC) configured to drive the display panel based on display data, the source driver IC including a logic circuit configured to receive a transmission data packet having data, a compression code indicating compression or non-compression of the data, and a clock signal, to interpret the compression code, and to generate a sleep mode enable signal based on an interpretation result, and a clock signal recovery circuit configured to enable one of a voltage-controlled delay line and a voltage-controller oscillator in response to the sleep mode enable signal,
wherein the logic circuit is configured to recover the display data from the data based on recovery clock signals output from one of the voltage-controlled delay line and the voltage-controller oscillator.

16. The display device of claim 15, wherein:
the voltage-controlled delay line includes a plurality of voltage-controlled delay line cells connected in series;
the clock signal recovery circuit includes:
an inverter configured to receive an output signal of one of the voltage-controlled delay line cells; and
a selection circuit configured to apply one of a reference clock signal generated based on the clock signal and an output signal of the inverter to a first voltage-controlled delay line cell in response to the sleep mode enable signal; and
the voltage-controller oscillator includes some of the voltage-controlled delay line cells and the inverter.

17. The display device of claim 15, wherein the voltage-controlled delay line is configured to generate the recovery clock signals in response to the sleep mode enable signal indicating non-compression of the data and the voltage-controller oscillator is configured to generate the recovery clock signals in response to the sleep mode enable signal indicating compression of the data.

18. The display device of claim 15, further comprising a control voltage maintaining circuit configured to supply a constant control voltage to the voltage-controller oscillator in response to the sleep mode enable signal.

19. The display device of claim 15, wherein the voltage-controller oscillator is configured to share a part of the voltage-controlled delay line.

20. The display device of claim 19, further comprising:
a reference clock generation circuit configured to generate a reference clock signal based on the clock signal;
a phase-frequency detector configured to receive the reference clock signal and an output clock signal of the voltage-controlled delay line;
a control voltage generation circuit configured to generate a control voltage in response to at least one control signal output from the phase-frequency detector, the control voltage supplied to the voltage-controlled delay line; and
a control voltage maintaining circuit configured to maintain the control voltage constant in response to the sleep mode enable signal.

21. The display device of claim 19, further comprising:
a reference clock generation circuit configured to generate a reference clock signal based on the clock signal;
a bang-bang phase detector configured to receive the reference clock signal and an output clock signal of the voltage-controlled delay line; and
a control voltage supply circuit configured to generate a count value in response to at least one control signal output from the bang-bang phase detector, to generate a control voltage based on the count value, and to supply the control voltage to the voltage-controlled delay line.

22. The display device of claim 19, further comprising:
a reference clock generation circuit configured to generate a reference clock signal based on the clock signal;
a time-to-digital converter configured to receive the reference clock signal and an output clock signal of the voltage-controlled delay line;
a digital loop filter connected to the time-to-digital converter; and
a control voltage supply circuit configured to generate a control voltage based on a control code output from the digital loop filter and to supply the control voltage to the voltage-controlled delay line.

23. The display device of claim 15, wherein the display device is a mobile equipment.

24. A method of operating a display interface, the method comprising:
comparing previous line data with current line data;
generating a compression code indicating compression or non-compression of the current line data based on a comparison result;
compressing the current line data based on the compression code;
generating a transmission data packet including the compression code, compressed data, and sleep data; and
transmitting the transmission data packet through a channel.

25. The method of claim 24, further comprising:
receiving the transmission data packet through the channel;
interpreting the compression code included in the transmission data packet;
generating a sleep mode enable signal based on an interpretation result; and
enabling one of a voltage-controlled delay line and a voltage-controller oscillator in response to the sleep mode enable signal.

26-32. (canceled)

33. An integrated circuit, comprising:
a first circuit configured to receive a data packet that includes information related to a sleep mode and to generate a signal in response to the information; and
a second circuit configured to enable one of a voltage-controlled delay line and a voltage-controller oscillator in response to the signal.

34. The integrated circuit of claim 33, wherein:
the voltage-controlled delay line includes a first voltage-controlled delay line and a second voltage-controlled delay line; and
the voltage-controller oscillator includes the first voltage-controlled delay line and an inverter.

35-38. (canceled)
